(19) United States
(12) Patent Application Publication
(10) Pub. No.: US 2004/0006293 A1
(43) Pub. Date: Jan. 8, 2004

(54) Bathing massage device

(76) Inventor: Chu-Chau Huang, Taipei (TW)

Correspondence Address: CHU-CHAU HUANG, P.O. BOX, 26-757, TAIPEI, TW

(21) Appl. No.: 10/192,937

(22) Filed: Jul. 8, 2002

(51) Int. Cl. A61H 15/00

(52) U.S. Cl. 601/134; 601/135; 601/137

(57) ABSTRACT

A bathing massage device comprises massage balls, an elastic body, and a knitted body. A groove is annularly disposed on each of the massage balls. The elastic body can be cut into a specific shape. Several circular holes can be freely disposed in the elastic body. After the massage balls are fixedly assembled in the circular holes with the grooves, the knitted body sheathes the elastic body and is then sewed closed. The shape of the knitted body corresponds to that of the elastic body. The bathing massage device has the advantages of simple assembly, diversified shapes, and convenient use.

### FIELD OF THE INVENTION

The present invention relates to a bathing massage device and, more particularly, to a massage device having massage balls positioned in an elastic body of a specific shape and then sewed in a knitted body for massage when bathing.

### BACKGROUND OF THE INVENTION

Nowadays, because people need to comfort the stiffened body due to life stress and work pressure, skin and flesh conditioning or hydropathy massage is in fashion. Various kinds of tools for health and body care have been proposed and continually improved. Sanitary emulsion or liquid having a curative effect can be absorbed and stored in a knitted body slipped outside a bathing massage device, and massage balls in the knitted body can be utilized to knead the body, thereby doubling the massage effect. This bathing massage device is especially suitable for family use. Old persons can use the bathing massage device to simultaneously bathe and massage at home without the need of going out and spending money. Moreover, parents can use the bathing massage device when bathing with children to enhance parenthood. As shown in FIGS. 1 to 3, a massage ball limit structure of a conventional bathing band comprises a bag body 1, massage balls 2, a rope body 3, and a limit component 4. The bag body 1 is formed by sewing pad cloth and nylon cloth together. One side thereof is open to receive the massage balls, and pad cloth and a sewed side is pre-reserved. The sewed side is turned for sealing and fixation and passed through by the rope body 3. The massage balls 2 are arranged in two adjacent rows. The limit component 4 is disposed between four adjacent massage balls 2. The limit component 4 is fixedly connected at the corresponding face of the bag body 1. The massage balls 2 are positioned within a specific range by the limit component 4. The limit component 4 can be a suture 5 directly passing and tied on the bag body 1 in parallel or crossed form, or a positioning piece 6 having a through hole placed between the massage balls 2, or a male buckle 7 and a female buckle 8 buckled between the massage balls 2 at the outside of the corresponding face of the bag body 1.

When manufacturing the above conventional bathing band, the massage balls must be placed and steadied in the bag body first. Next, a suture directly passing and tied on the bag body is used, or positioning pieces are placed at the desired positions, or through holes at the outside of the bag body are buckled with the male and female buckles. The number of components is large, and the assembly is time-consuming. In consideration of the size of the limit component, it is necessary to arrange the massage balls adjacent to one another to reduce the cost of suture. Therefore, the bathing band is of an undiversified rectangular band shape, hence restricting the design space. Moreover, the size and spacing of massage balls affects use and massage limit of the bathing band.

Accordingly, the conventional bathing massage device has inconvenience and drawbacks in practical manufacture and use. The present invention aims to propose a modified bathing massage device to resolve the problems in the prior art.

### SUMMARY OF THE INVENTION

The primary object of the present invention is to provide a bathing massage device comprising massage balls, an elastic body, and a knitted body. After the massage balls are fixed in the elastic body, the knitted body sheathes the elastic body and is then sewed closed. Therefore, the components are simplified, and the assembly time is saved.

Another object of the present invention is to provide a bathing massage device comprising massage balls, an elastic body, and a knitted body. The elastic body can be cut into various kinds of shapes, and is not limited by the limit component and arrangement of massage balls.

Another object of the present invention is to provide a bathing massage device comprising massage balls, an elastic body, and a knitted body. The elastic body can freely turn around and deform to match the body shape of each age group.

To achieve the above objects, the present invention provides a bathing massage device comprising massage balls, an elastic body, and a knitted body. A groove is annularly disposed on the massage ball. The elastic body can be cut into a specific shape. Several circular holes can be freely disposed in the elastic body. After the massage balls are fixedly assembled in the circular holes, the knitted body sheathes the elastic body and is then sewed closed.

The various objects and advantages of the present invention will be more readily understood from the following detailed description when read in conjunction with the appended drawing, in which:

### BRIEF DESCRIPTION OF THE DRAWINGS

FIG. 1 is a perspective view of a conventional bathing band;

FIG. 2 is a cross-sectional view of another conventional bathing band;

FIG. 3 is a cross-sectional view of yet another conventional bathing band;

FIG. 4 is a perspective view of a massage ball of the present invention;

FIG. 5 is a cross-sectional view of a first embodiment of the present invention;

FIG. 6 is a plan view of the first embodiment of the present invention;

FIG. 7 is a plan view of a second embodiment of the present invention;

FIG. 8 is a plan view of a third embodiment of the present invention;

FIG. 9 is a plan view of a fourth embodiment of the present invention; and

FIG. 10 is a plan view of a fifth embodiment of the present invention;

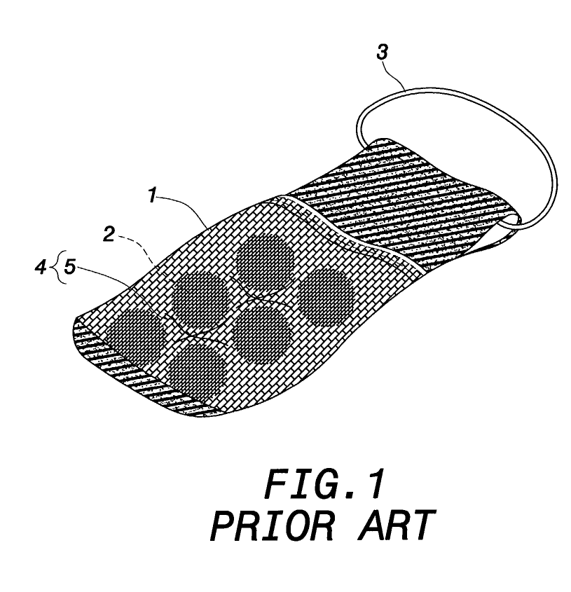

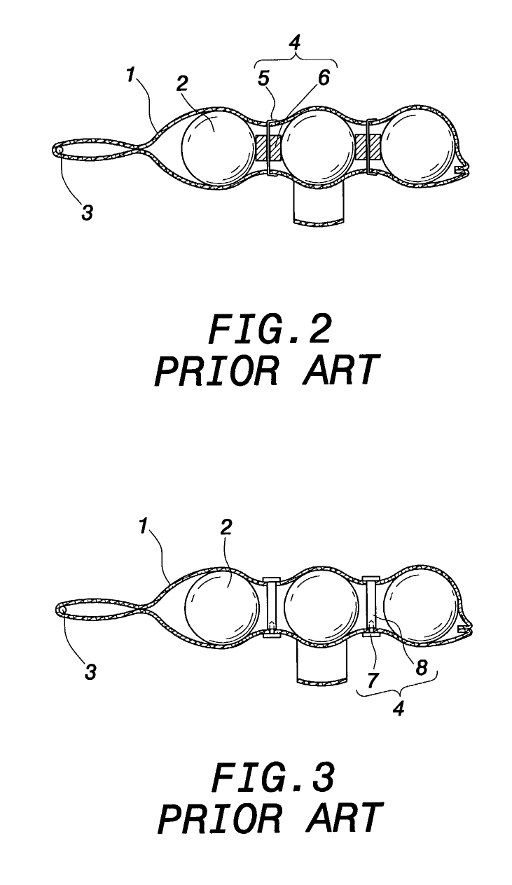

### DETAILED DESCRIPTION OF THE PREFERRED EMBODIMENTS

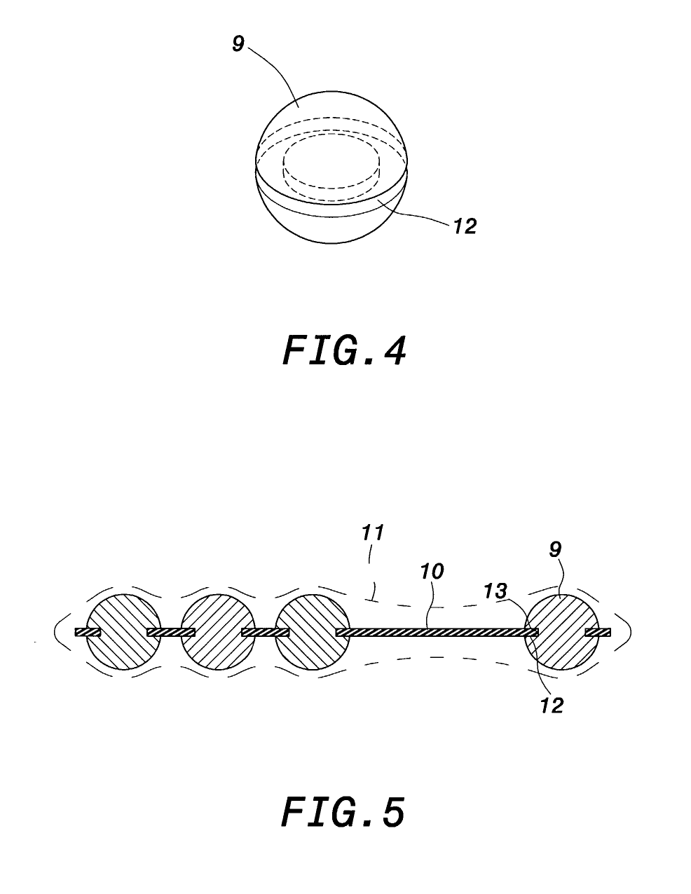

As shown in FIGS. 4 to 6, the present invention provides a bathing massage device comprising massage balls 9, an elastic body 10, and a knitted body 11.

The massage balls can be formed by injection molding. A groove 12 is annularly disposed on the spherical surface thereof.

The elastic body 10 can be a rubber, and is used to fix the massage balls 9. The elastic body 10 can be cut into various kinds of shapes. The thickness of the elastic body corresponds to the width of the groove 12 of the massage ball 9. Several circular holes 13 are disposed in the elastic body 10. The diameter of the circular hole 13 is between the diameter of the massage ball 9 and the diameter of the ring formed by the groove 12. When installing the massage balls 9, the massage balls 9 are jammed into the circular holes 13 with smooth curved plane thereof matched with elasticity of the elastic body 10. The groove 12 on the surface of the massage ball is thus retained in the circular hole 13. Due to free arrangement of the circular holes 13 and elasticity of the elastic body 10, the bathing massage device of the present invention can adequately turn around to match the body shape of each age group.

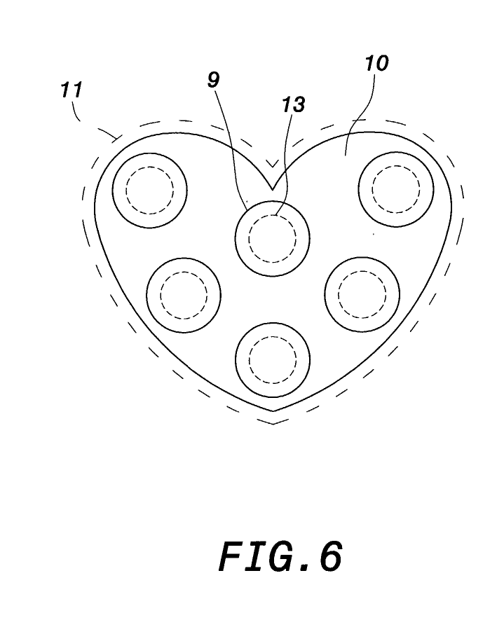

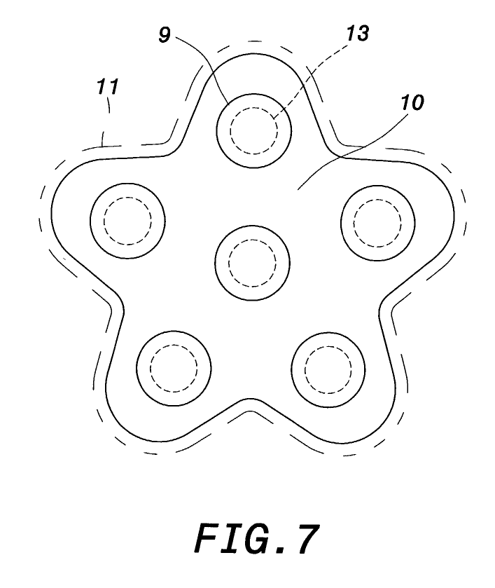

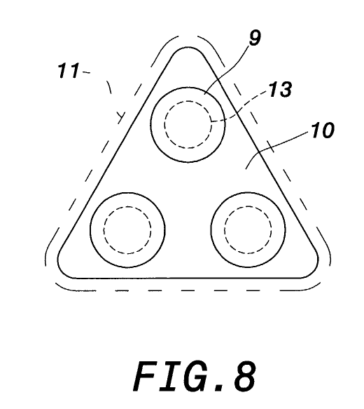

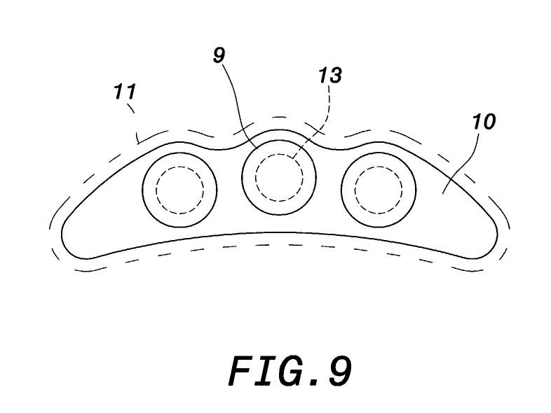

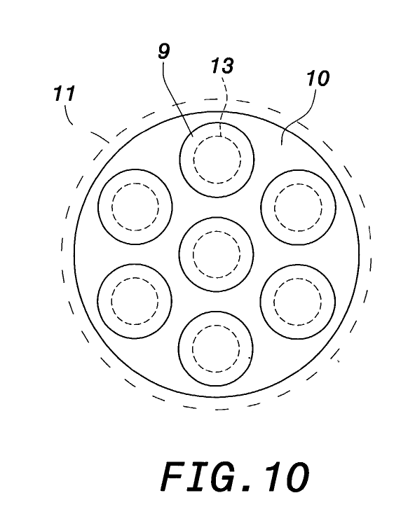

The knitted body 11 sheathes the massage balls 9 and the elastic body 10 and is then sewed closed. Because the elastic body 10 has finished fixation and assembly of the massage balls 9, the sewing of the knitted body 11 only aims at the elastic body 10. It is not necessary to take the limit problem of the massage balls 9 into account, hence simplifying many cumbersome procedures. The shape of the knitted body 11 corresponds to the elastic body 10. FIGS. 6 to 10 show other embodiments of the present invention. The elastic body 10 can be of a heart shape, a star shape, a triangular shape, a pea shape, or a circular shape. Because the elastic body 10 can be cut into different shapes. The bathing massage device of the present invention has copious outward appearances, and can be packaged into various kinds of styles for selection.

To sum up, the bathing massage device of the present invention has the following characteristics.

(1) After the massage balls are first fixed in the elastic body, the knitted body sheathes them and is then sewed closed. The components are simplified, and the assembly time is saved.

(2) The elastic body can be cut into various kinds of shapes, and is not limited by a limit component and arrangement of the massage balls. The knitted body can have several kinds of outward appearances to satisfy different liking of users.

(3) Due to flexible distribution of the massage balls and free turning around of the elastic body, the bathing massage device can match the body shape of each age group.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A bathing massage device comprising:
massage balls each having a groove annularly disposed on a spherical surface thereof;
an elastic body having circular holes disposed therein, said circular holes being used for fixed assembly of said grooves of said massage balls; and
a knitted body for sheathing and sewing said elastic body and said massage balls closed.

2. The bathing massage device as claimed in claim 1, wherein the diameter of said circular hole is between the diameter of said massage ball and the diameter of a ring formed by said groove.

3. The bathing massage device as claimed in claim 1, wherein said massage balls are formed by injection molding.

4. The bathing massage device as claimed in claim 1, wherein said elastic body is a rubber.

5. The bathing massage device as claimed in claim 1, wherein the shape of said knitted body corresponds to that of said elastic body.

6. The bathing massage device as claimed in claim 5, wherein said knitted body is of a heart shape.

7. The bathing massage device as claimed in claim 5, wherein said knitted body is of a star shape.

8. The bathing massage device as claimed in claim 5, wherein said knitted body is of a triangular shape.

9. The bathing massage device as claimed in claim 5, wherein said knitted body is of a pea shape.

10. The bathing massage device as claimed in claim 5, wherein said knitted body is of a circular shape.
